(19) United States
(12) Patent Application Publication
(10) Pub. No.: US 2021/0269032 A1
(43) Pub. Date: Sep. 2, 2021

(54) CONTROL DEVICE FOR VEHICLE DRIVE DEVICE

(71) Applicant: AISIN AW CO., LTD., Anjo-shi, Aichi-ken (JP)

(72) Inventors: Nobuhiro HOSOI, Anjo, Aichi (JP); Daiki SUGIMOTO, Kariya, Aichi (JP)

(73) Assignee: AISIN AW CO., LTD., Anjo-shi, Aichi-ken (JP)

(21) Appl. No.: 17/258,263

(22) PCT Filed: Aug. 22, 2019
(86) PCT No.: PCT/JP2019/032789

§ 371 Date: Jan. 6, 2021

(30) Foreign Application Priority Data
Aug. 31, 2018 (JP) 2018-162779

(51) Int. Cl. B60W 30/18; B60W 30/19

(52) U.S. Cl. CPC B60W 30/18072; B60W 2510/1075; B60W 2030/18081; B60W 30/19

(57) ABSTRACT

A controller for a vehicle drive device includes an engagement control part controlling an engagement state of a first engagement device based on an engagement control instruction; a hydraulic pressure information obtaining part obtaining hydraulic pressure information indicating first hydraulic pressure supplied to the first engagement device; an acceleration information obtaining part obtaining acceleration information indicating vehicle acceleration; and a determining part determining a state of the first engagement device, and when an input rotational speed is greater than zero, a state of a transmission is a drive transmission state in which drive power is transmitted, the engagement control instruction is a disengagement instruction brining the first engagement device into a disengaged state, the first hydraulic pressure is greater than a first threshold value, and the acceleration has a negative value smaller than a second threshold value, the determining part determines the first engagement device state is an engagement abnormality.

### CROSS REFERENCE TO RELATED APPLICATIONS

This application is a National Stage of International Application No. PCT/JP2019/032789 filed Aug. 22, 2019, which designates the United States, incorporated herein by reference, and which claims the benefit of priority from Japanese Patent Application No. 2018-162779 filed Aug. 31, 2018 the contents of which are incorporated in their entirety.

### TECHNICAL FIELD

The present disclosure relates to a control device whose control target is a vehicle drive device in which in a power transmission path connecting an input member drive-coupled to an internal combustion engine to an output member drive-coupled to wheels, an engagement device that operates by hydraulic pressure, a rotating electrical machine, and a transmission are provided in this order from an internal combustion engine side.

### BACKGROUND ART

An example of such a control device is disclosed in the following Patent Literature 1. In the following, in description of the Background Art section, reference signs in Patent Literature 1 are quoted in parentheses.

In a control device (30) of Patent Literature 1, an engagement control part (44) controls a state of engagement of an engagement device (CL1) based on an instruction from an instruction device (46). However, despite the fact that the engagement control part (44) receives from the instruction device (46) a disengagement instruction to bring the engagement device (CL1) into a disengaged state, a situation in which the engagement device (CL1) goes into an engaged state can occur due to a failure of the engagement control part (44), a computation error of the engagement control part (44), a failure of the engagement device (CL1), etc. Patent Literature 1 does not describe this matter, but when such a situation occurs in a state in which drive power of a rotating electrical machine (MG) is transmitted to wheels (e.g., EV mode), power is transmitted between an internal combustion engine (ENG) and the rotating electrical machine (MG), and thus, the rotational speed of the rotating electrical machine (MG) decreases by the inertia torque of the internal combustion engine (ENG) and there has been a possibility of unintended deceleration of a vehicle.

### CITATIONS LIST

### Patent Literature

Patent Literature 1: WO 2016/084474 A (FIG. 1)

### SUMMARY OF THE DISCLOSURE

### Technical Problems

Hence, it is desired to implement a control device for a vehicle drive device that can determine unintended deceleration of a vehicle in a state in which drive power of a rotating electrical machine is transmitted to wheels.

### Solutions to Problems

A characteristic configuration of a control device for a vehicle drive device in view of the above description is such that

the control device is a control device whose control target is a vehicle drive device in which in a power transmission path connecting an input member drive-coupled to an internal combustion engine to an output member drive-coupled to wheels, a first engagement device that operates by hydraulic pressure, a rotating electrical machine, and a transmission are provided in this order from an internal combustion engine side, and the control device includes:

an engagement control part that controls a state of engagement of the first engagement device based on an engagement control instruction;

a hydraulic pressure information obtaining part that obtains hydraulic pressure information indicating first hydraulic pressure supplied to the first engagement device;

an acceleration information obtaining part that obtains acceleration information indicating acceleration of a vehicle on which the vehicle drive device is provided; and

a determining part that determines a state of the first engagement device, and

when

an input rotational speed is greater than zero and a state of the transmission is a drive transmission state in which drive power is transmitted, the input rotational speed being a rotational speed of the rotating electrical machine;

the engagement control instruction is a disengagement instruction to bring the first engagement device into a disengaged state;

the first hydraulic pressure indicated by the hydraulic pressure information is greater than a first threshold value; and

acceleration indicated by the acceleration information has a negative value smaller than a second threshold value,

the determining part determines that the state of the first engagement device is an engagement abnormality where the state of the first engagement device is an engaged state in contrast to the disengagement instruction.

According to the characteristic configuration, when the first engagement device goes into an engaged state in contrast to a disengagement instruction during acceleration or deceleration of the vehicle or during coasting of the vehicle in a state in which drive power of the rotating electrical machine is transmitted to the wheels, and the acceleration of the vehicle becomes a negative value smaller than a specified value, it is determined that the state of the first engagement device is an engagement abnormality. Therefore, unintended deceleration of the vehicle in a state in which drive power of the rotating electrical machine is transmitted to the wheels can be appropriately determined.

A characteristic configuration of a control device for a vehicle drive device in view of the above description is such that

the control device is a control device whose control target is a vehicle drive device in which in a power transmission path connecting an input member drive-coupled to an internal combustion engine to an output member drive-coupled to wheels, a first engagement device that operates by hydraulic pressure, a rotating electrical machine, and a transmission are provided in this order from an internal combustion engine side, and the control device includes:

an engagement control part that controls a state of engagement of the first engagement device based on an engagement control instruction;

a hydraulic pressure information obtaining part that obtains hydraulic pressure information indicating first hydraulic pressure supplied to the first engagement device;

an acceleration information obtaining part that obtains acceleration information indicating acceleration of a vehicle on which the vehicle drive device is provided; and

a determining part that determines a state of the first engagement device, and

when

an input rotational speed is greater than zero and a state of the transmission is a drive transmission state in which drive power is transmitted, the input rotational speed being a rotational speed of the rotating electrical machine;

the engagement control instruction is a disengagement instruction to bring the first engagement device into a disengaged state;

the first hydraulic pressure indicated by the hydraulic pressure information is greater than a first threshold value; and

acceleration indicated by the acceleration information has a negative value smaller than a second threshold value,

the determining part performs at least one of first control that brings the first engagement device into a disengaged state and second control that interrupts transmission of drive power between the rotating electrical machine and the output member.

According to the characteristic configuration, when the first engagement device goes into an engaged state in contrast to a disengagement instruction during acceleration or deceleration of the vehicle or during coasting of the vehicle in a state in which drive power of the rotating electrical machine is transmitted to the wheels, and the acceleration of the vehicle becomes a negative value smaller than a specified value, at least one of interruption of power transmission between the internal combustion engine and the rotating electrical machine and interruption of power transmission between the rotating electrical machine and the output member is performed. Hence, unintended transmission of inertia torque of the internal combustion engine to the wheels caused by an engagement abnormality in the first engagement device can be avoided. Therefore, unintended deceleration of the vehicle in a state in which drive power of the rotating electrical machine is transmitted to the wheels can be avoided.

### BRIEF DESCRIPTION OF DRAWINGS

FIG. 1 is a schematic diagram showing configurations of a vehicle drive device and a control device according to a first embodiment.

FIG. 2 is a block diagram showing a configuration of the control device according to the first embodiment.

FIG. 3 is a flowchart showing a determination of a state of a first engagement device by a determining part.

FIG. 4 is a time chart showing a determination of a state of the first engagement device by the determining part.

FIG. 5 is a schematic diagram showing configurations of a vehicle drive device and a control device according to a second embodiment.

### DESCRIPTION OF EMBODIMENTS

### First Embodiment

In the following, a control device 10 for a vehicle drive device 1 according to a first embodiment will be described with reference to drawings. The control device 10 is a device whose control target is the vehicle drive device 1. The control device 10 together with the vehicle drive device 1 is mounted on a vehicle. In the present embodiment, an internal combustion engine control device 20 is also mounted on the vehicle. The internal combustion engine control device 20 is a device that controls an internal combustion engine ENG serving as a drive power source.

1. Configuration of the Vehicle Drive Device

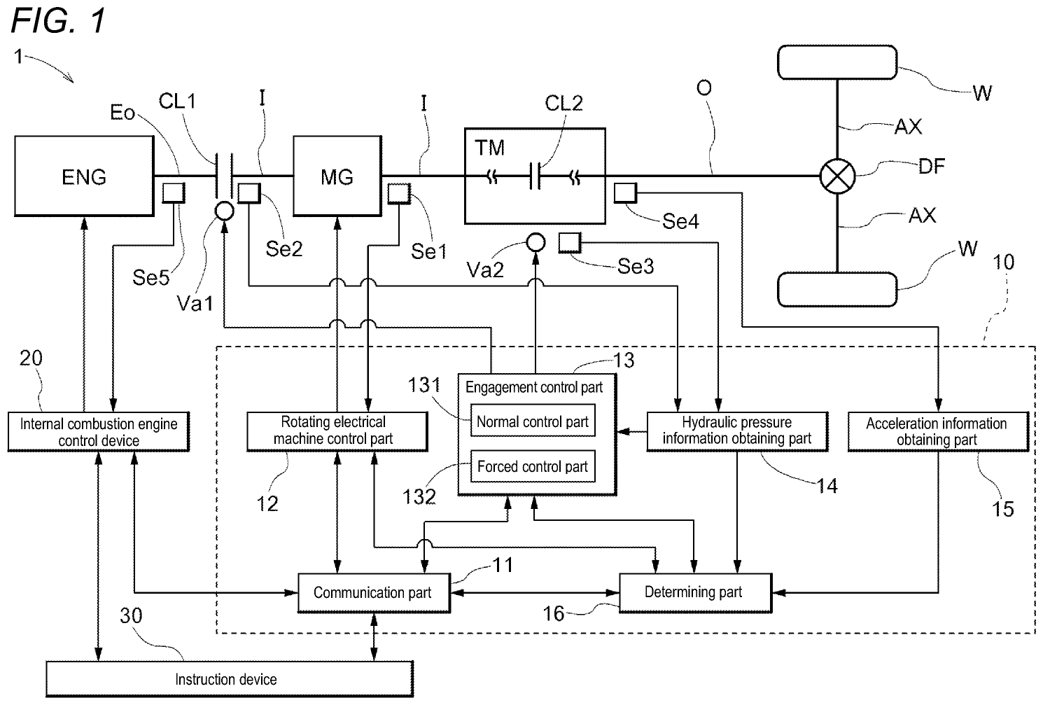

First, a configuration of the vehicle drive device 1 will be described. As shown in FIG. 1, the vehicle drive device 1 includes an input shaft I drive-coupled to the internal combustion engine ENG; an output shaft O drive-coupled to wheels W; a rotating electrical machine MG; a first engagement device CL1 that selectively drive-couples the internal combustion engine ENG to the rotating electrical machine MG; and a transmission TM that changes the speed of rotation of the input shaft I and transmits the rotation to the output shaft O. In a power transmission path connecting the input shaft I to the output shaft O, the first engagement device CL1, the rotating electrical machine MG, and the transmission TM are disposed in this order from an internal combustion engine ENG side. Note that in the present embodiment, the input shaft I corresponds to an “input member” and the output shaft O corresponds to an “output member”.

Here, the term “drive-coupled” indicates a state in which two rotating elements are coupled together such that they can transmit drive power, and includes a state in which the two rotating elements are coupled together such that they rotate together or a state in which the two rotating elements are coupled together through one or two or more power transmission members such that they can transmit drive power. Such power transmission members include various types of members (e.g., shafts, gear mechanisms, belts, and chains) that transmit rotation at the same speed or at a changed speed. Note that the power transmission members may include engagement devices (e.g., friction engagement devices and mesh engagement devices) that selectively transmit rotation and drive power.

The internal combustion engine ENG is a prime mover (a gasoline engine, a diesel engine, etc.) that is driven by fuel combustion to take out power. In the present embodiment, an internal combustion engine output shaft Eo such as a crankshaft of the internal combustion engine ENG is selectively drive-coupled to the input shaft I through the first engagement device CL1. The internal combustion engine output shaft Eo is provided with a damper (depiction is omitted) that damps fluctuation of torque to be transmitted.

The rotating electrical machine MG includes a stator and a rotor that is rotatably supported on the stator. The rotor of the rotating electrical machine MG is drive-coupled to the input shaft I so as to rotate together with the input shaft I. That is, in the present embodiment, the configuration is such that both the internal combustion engine ENG and the rotating electrical machine MG are drive-coupled to the input shaft I. The rotating electrical machine MG is electrically connected to a battery (an example of an electrical storage device, the same applies hereinafter) through an inverter that performs DC-AC conversion. The rotating electrical machine MG has a function of a motor that receives electric power supply and thereby generates power and a function of a generator that receives power supply and thereby generates electric power. That is, the rotating electrical machine MG performs motoring by receiving electric power supply from the battery through the inverter, or stores electric power generated by torque of the internal combustion engine ENG or inertial force of the vehicle in the battery through the inverter.

The transmission TM includes one or more second engagement devices CL2 that are brought into an engaged state when a shift speed is formed. The transmission TM forms a shift speed determined based on the states of engagement of the second engagement devices CL2, changes the speed of rotation of the input shaft I at a gear ratio determined based on the shift speed, and transmits the rotation to the output shaft O. Torque transmitted from the transmission TM to the output shaft O is distributed to a plurality of (two in this example) axles AX through a differential gear device DF and transmitted to the wheels W drive-coupled to the respective axles AX.

The first engagement device CL1 and the second engagement devices CL2 each are an engagement device that operates by hydraulic pressure. In the present embodiment, the first engagement device CL1 and the second engagement devices CL2 each are a friction engagement device. The friction engagement device is configured such that the state of engagement is controlled based on hydraulic pressure supplied to the friction engagement device.

The friction engagement device transmits torque between a pair of fiction members included in the friction engagement device by friction between the pair of friction members. When there is a rotational speed difference (slippage) between the pair of friction members of the friction engagement device, torque (slip torque) whose magnitude is transmission torque capacity is transmitted by dynamic friction from a member with a higher rotational speed to a member with a lower rotational speed. When there is no rotational speed difference (slippage) between the pair of friction members of the friction engagement device, the friction engagement device transmits, by static friction, torque acting between the pair of friction members, with the magnitude of transmission torque capacity being an upper limit. Here, the transmission torque capacity is the magnitude of maximum torque that can be transmitted by the friction engagement device by friction. The magnitude of the transmission torque capacity changes in proportion to the engagement pressure of the friction engagement device. The engagement pressure is pressure that presses a friction member on an input side and a friction member on an output side against each other. The engagement pressure changes in proportion to the magnitude of supplied hydraulic pressure. That is, the magnitude of the transmission torque capacity changes in proportion to the magnitude of hydraulic pressure supplied to the friction engagement device.

The friction engagement device includes a return spring, and the friction members are biased toward a disengagement side by reaction force of the return spring. When force generated by hydraulic pressure supplied to a hydraulic cylinder of the friction engagement device exceeds the reaction force of the return spring, transmission torque capacity starts to be generated in the friction engagement device, by which the friction engagement device changes from a disengaged state to an engaged state. The hydraulic pressure at which transmission torque capacity starts to be generated is referred to as stroke end pressure. The friction engagement device is configured such that after supplied hydraulic pressure exceeds the stroke end pressure, the transmission torque capacity increases in proportion to an increase in the hydraulic pressure. Note that the friction engagement device may be structured such that the friction engagement device does not include a return spring and is controlled by differential pressure of hydraulic pressure applied to both sides of a piston of the hydraulic cylinder.

Here, the “engaged state” is a state in which transmission torque capacity is generated in the friction engagement device, and includes a slip-engaged state and a direct-coupling engaged state. The “slip-engaged state” is an engaged state in which there is a rotational speed difference (slippage) between the pair of friction members of the friction engagement device. The “direct-coupling engaged state” is an engaged state in which there is no rotational speed difference (slippage) between the pair of friction members of the friction engagement device. In addition, the “disengaged state” is a state in which transmission torque capacity is not generated in the friction engagement device.

2. Configurations of the Control Devices

Next, configurations of the control device 10 that controls the vehicle drive device 1 and the internal combustion engine control device 20 that controls the internal combustion engine ENG will be described.

The control device 10 and the internal combustion engine control device 20 each include, as a core member, an arithmetic processing device such as a CPU and include storage devices such as a random access memory (RAM) from which data can be read and into which data can be written by the arithmetic processing device and a read only memory (ROM) from which data can be read by the arithmetic processing device. Furthermore, the control device 10 and the internal combustion engine control device 20 each include software (programs) stored in the storage devices, hardware provided separately such as an arithmetic circuit, or both of them.

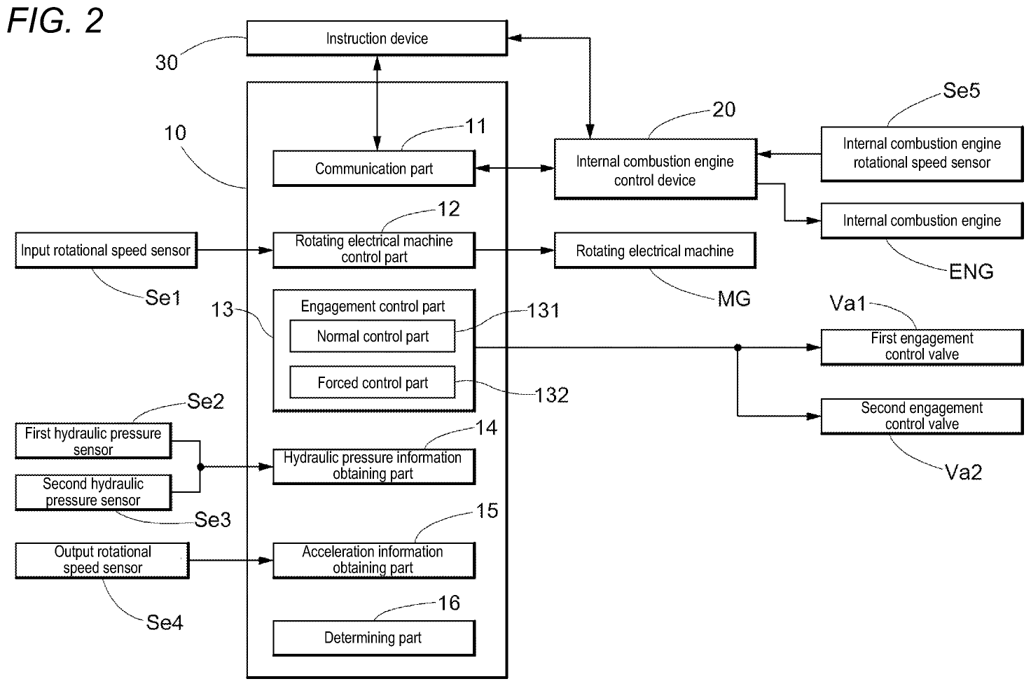

As shown in FIGS. 1 and 2, the control device 10 includes an engagement control part 13, a hydraulic pressure information obtaining part 14, an acceleration information obtaining part 15, and a determining part 16. In the present embodiment, the control device 10 also includes a communication part 11 and a rotating electrical machine control part 12.

The communication part 11 is configured to be able to communicate with an instruction device 30 which is a host control device for the control device 10 and the internal combustion engine control device 20. The communication part 11 receives from the instruction device 30 a rotating electrical machine control instruction which is an instruction for the rotating electrical machine control part 12, an engagement control instruction which is an instruction for the engagement control part 13, etc. In addition, the communication part 11 is configured to be able to communicate with the rotating electrical machine control part 12, the engagement control part 13, and the internal combustion engine control device 20, too. Note that the internal combustion engine control device 20 and the instruction device 30 may be included in the same device.

The rotating electrical machine control part 12 controls the rotating electrical machine MG. When target torque required for the rotating electrical machine MG is instructed by the instruction device 30 through the communication part 11, the rotating electrical machine control part 12 controls the rotating electrical machine MG to output the target torque. In addition, when a target rotational speed required for the rotating electrical machine MG is instructed by the instruction device 30 through the communication part 11, the rotating electrical machine control part 12 controls the rotating electrical machine MG to achieve the target rotational speed. Specifically, the rotating electrical machine control part 12 controls the output torque and rotational speed of the rotating electrical machine MG by controlling the inverter that drives the rotating electrical machine MG.

In addition, the rotating electrical machine control part 12 calculates an input rotational speed Nm which is the rotational speed (angular speed) of the input shaft I, based on an output signal from an input rotational speed sensor Se1. The input rotational speed sensor Se1 is a sensor for detecting the input rotational speed Nm. For the input rotational speed sensor Se1, a resolver, a sensor using a magnetoresistive element (MR element), a sensor using a Hall element, etc., can be adopted. Note that, as described above, since the rotor of the rotating electrical machine MG is integrally drive-coupled to the input shaft 1, the rotational speed of the input shaft I corresponds to the rotational speed of the rotating electrical machine MG.

The engagement control part 13 controls the state of engagement of the first engagement device CL1 based on the above-described engagement control instruction. In the present embodiment, the engagement control part 13 controls a first engagement control valve Va1 such that first hydraulic pressure P1 supplied to the first engagement device CL1 matches target hydraulic pressure (hydraulic pressure instruction) of the first engagement device CL1 that is included in the engagement control instruction. In the present embodiment, the first engagement control valve Va1 is a solenoid valve that adjusts hydraulic pressure to be supplied to a hydraulic servomechanism of the first engagement device CL1, based on current applied thereto.

In addition, the engagement control part 13 controls the state of the transmission TM by controlling the states of engagement of the second engagement devices CL2 in the transmission TM. In the present embodiment, the engagement control part 13 controls second engagement control valves Va2 such that second hydraulic pressure P2 supplied to the second engagement devices CL2 matches target hydraulic pressure (hydraulic pressure instruction) of the second engagement devices CL2 instructed by the instruction device 30. In the present embodiment, the second engagement control valves Va2 are solenoid valves that adjust hydraulic pressure to be supplied to hydraulic servomechanisms of the second engagement devices CL2, based on current applied thereto. Note that in the present embodiment, the second engagement control valves Va2 are provided for the respective plurality of second engagement devices CL2. That is, the second engagement control valves Va2 whose number is the same as the number of the second engagement devices CL2 are provided. Note, however, that the number of the second engagement control valves Va2 may be smaller than the number of the second engagement devices CL2. In this case, an oil passage switching mechanism (oil passage switching valve) that switches the supply destination of hydraulic pressure between the plurality of second engagement devices CL2 (the plurality of hydraulic servomechanisms) is provided more on a downstream side than the second engagement control valve Va2.

The hydraulic pressure information obtaining part 14 obtains hydraulic pressure information indicating first hydraulic pressure P1 supplied to the first engagement device CL1. In the present embodiment, the hydraulic pressure information obtaining part 14 calculates first hydraulic pressure P1 based on an output signal from a first hydraulic pressure sensor Se2. The first hydraulic pressure sensor Se2 is a sensor for detecting first hydraulic pressure P1 supplied to the first engagement device CL1. The first hydraulic pressure sensor Se2 is provided, for example, in an oil passage connecting the first engagement control valve Va1 to the hydraulic servomechanism of the first engagement device CL1.

In addition, the hydraulic pressure information obtaining part 14 obtains hydraulic pressure information indicating second hydraulic pressure P2 supplied to the second engagement devices CL2. In the present embodiment, the hydraulic pressure information obtaining part 14 calculates second hydraulic pressure P2 based on an output signal from a second hydraulic pressure sensor Se3. The second hydraulic pressure sensor Se3 is a sensor for detecting second hydraulic pressure P2 supplied to the second engagement devices CL2. The second hydraulic pressure sensor Se3 is provided, for example, in an oil passage connecting the second engagement control valves Va2 to the hydraulic servomechanisms of the second engagement devices CL2.

The acceleration information obtaining part 15 obtains acceleration information indicating acceleration A of the vehicle having the vehicle drive device 1 provided thereon. In the present embodiment, the acceleration information obtaining part 15 calculates the rotational speed (angular speed) of the output shaft O based on an output signal from an output rotational speed sensor Se4. Then, the acceleration information obtaining part 15 calculates acceleration A of the vehicle based on a change in the rotational speed of the output shaft O. For the output rotational speed sensor Se4, a resolver, a sensor using a magnetoresistive element (MR element), a sensor using a Hall element, etc., can be adopted.

Note that the acceleration A of the vehicle can be calculated, for example, by the following equation.

Acceleration A of the vehicle=a change in the rotational speed of the output shaft O (the differential value of rotational speed of the output shaft O)×the circumference of the wheels W/the gear ratio of the differential gear device DF

The determining part 16 determines a state of the first engagement device CL1 based on hydraulic pressure information obtained by the hydraulic pressure information obtaining part 14, acceleration information obtained by the acceleration information obtaining part 15, etc. Specific operation of the determining part 16 will be described later.

When a combustion start request for the internal combustion engine ENG has been made, the internal combustion engine control device 20 performs control to start combustion of the internal combustion engine ENG, for example, by starting the fuel supply and ignition of the internal combustion engine ENG. In addition, when a combustion stop instruction for the internal combustion engine ENG has been made by the instruction device 30 through the communication part 11, the internal combustion engine control device 20 brings the internal combustion engine ENG into a combustion stop state by stopping the fuel supply, ignition, etc., of the internal combustion engine ENG. Furthermore, the internal combustion engine control device 20 controls the internal combustion engine ENG to output target torque instructed by the instruction device 30 through the communication part 11 or to achieve a target rotational speed instructed by the instruction device 30 through the communication part 11.

In addition, the internal combustion engine control device 20 calculates an internal combustion engine rotational speed Ne which is the rotational speed (angular speed) of the internal combustion engine output shaft Eo (internal combustion engine ENG), based on an output signal from an internal combustion engine rotational speed sensor Se5. The internal combustion engine rotational speed sensor Se5 is a sensor for detecting the internal combustion engine rotational speed Ne. For the internal combustion engine rotational speed sensor Se5, a resolver, a sensor using a magnetoresistive element (MR element), a sensor using a Hall element, etc., can be adopted.

3. Determination of a State of the First Engagement Device CL1

Next, a determination of a state of the first engagement device CL1 by the determining part 16 will be described.

The determining part 16 determines that the state of the first engagement device CL1 is an engagement abnormality where the state of the first engagement device CL1 is an engaged state in contrast to a disengagement instruction, when the following conditions (a) to (e) are all satisfied:

(a) The input rotational speed Nm which is the rotational speed of the rotating electrical machine MG (input shaft I) is greater than zero;

(b) The state of the transmission TM is a drive transmission state in which drive power is transmitted;

(c) The engagement control instruction is a disengagement instruction to bring the first engagement device CL1 into a disengaged state;

(d) The first hydraulic pressure P1 is greater than a first threshold value TH1; and

(e) The acceleration A of the vehicle has a negative value smaller than a second threshold value TH2.

In the present embodiment, when the determining part 16 determines that the state of the first engagement device CL1 is an engagement abnormality, the determining part 16 performs at least one of first control that brings the first engagement device CL1 into a disengaged state and second control that interrupts transmission of drive power between the rotating electrical machine MG and the output shaft O.

In the present embodiment, the first control includes first disengagement control that allows the engagement control part 13 to perform control again to bring the first engagement device CL1 into a disengaged state; second disengagement control that allows the first engagement control valve Va1 to operate such that the first engagement device CL1 is forcefully brought into a disengaged state; and third disengagement control that allows the engagement control part 13 to restart.

In the present embodiment, the second control includes neutral control that brings the state of the transmission TM into a neutral state in which drive power is not transmitted. The neutral control includes normal neutral control that brings the transmission TM into a neutral state in normal control that allows the engagement control part 13 to control the states of engagement of the second engagement devices CL2 in the transmission TM; and forced neutral control that allows the second engagement control valves Va2 to operate such that the second engagement devices CL2 are forcefully brought into a disengaged state.

In the present embodiment, the engagement control part 13 includes a normal control part 131 and a forced control part 132. The normal control part 131 controls the state of engagement of each of the first engagement device CL1 and the second engagement devices CL2 mainly at normal times, based on an engagement control instruction, etc. The forced control part 132 forcefully controls the state of engagement of each of the first engagement device CL1 and the second engagement devices CL2 when it is determined that the state of the first engagement device CL1 is an engagement abnormality.

In the present embodiment, in the first disengagement control, the determining part 16 controls the normal control part 131 to bring the first engagement device CL1 into a disengaged state. In addition, in the second disengagement control, the determining part 16 controls the forced control part 132 to allow the first engagement control valve Va1 to operate such that the first engagement device CL1 is forcefully brought into a disengaged state. The forced control part 132 forcefully brings the first engagement device CL1 into a disengaged state, for example, by stopping supply of current to the first engagement control valve Va1. Note that the determining part 16 may be configured to control both the normal control part 131 and the forced control part 132 in the second disengagement control such that the first engagement device CL1 is brought into a disengaged state. By this, the first engagement device CL1 can be brought into a disengaged state with high reliability.

Furthermore, in the present embodiment, in the normal neutral control, the determining part 16 controls the normal control part 131 to bring the transmission TM into a neutral state. In addition, in the forced neutral control, the determining part 16 controls the forced control part 132 to allow the second engagement control valves Va2 to operate such that the second engagement devices CL2 are forcefully brought into a disengaged state. The forced control part 132 forcefully brings all of the second engagement devices CL2 into a disengaged state, for example, by stopping supply of current to all of the second engagement control valves Va2. Note that the determining part 16 may be configured to control both the normal control part 131 and the forced control part 132 in the forced neutral control such that the second engagement devices CL2 are brought into a disengaged state. By this, the second engagement devices CL2 can be brought into a disengaged state with high reliability.

In the present embodiment, the determining part 16 determines a state of the first engagement device CL1 when the input rotational speed Nm is higher than the internal combustion engine rotational speed Ne and a rotational speed difference ΔN between the input rotational speed Nm and the internal combustion engine rotational speed Ne is greater than a third threshold value TH3, and does not determine a state of the first engagement device CL1 when the rotational speed difference ΔN between the input rotational speed Nm and the internal combustion engine rotational speed Ne is less than or equal to the third threshold value TH3.

3-1. Flowchart

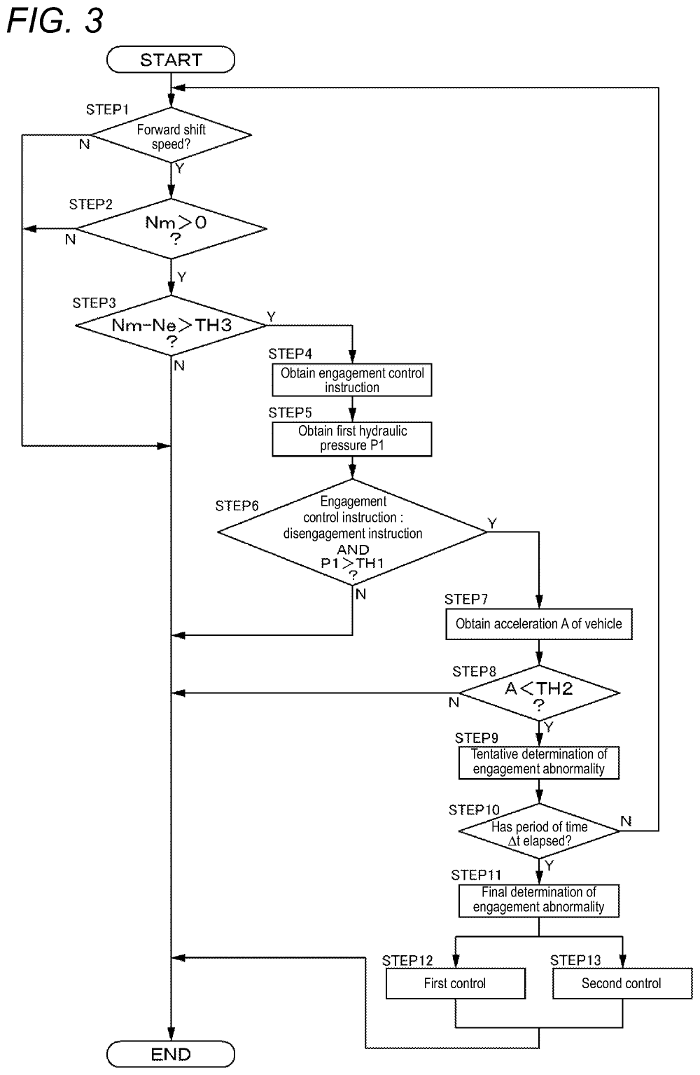

FIG. 3 shows a flowchart for an example of a determination of a state of the first engagement device CL1 by the determining part 16. As shown in FIG. 3, first, the determining part 16 determines whether the transmission TM has formed a forward shift speed (STEP1). This determination can be made, for example, based on second hydraulic pressure P2 supplied to the second engagement devices CL2 in the transmission TM that is calculated by the hydraulic pressure information obtaining part 14. Note that in the present application, a state in which the transmission TM has formed a forward shift speed corresponds to a “drive transmission state in which drive power is transmitted”. Here, the forward shift speed is a shift speed at which drive power for allowing the vehicle to travel forward is transmitted to the wheels W.

If the determining part 16 determines that the transmission TM has formed a forward shift speed, the determining part 16 determines whether the input rotational speed Nm is greater than zero (STEP2). This determination can be made, for example, based on information from the rotating electrical machine control part 12.

On the other hand, if the determining part 16 determines that the transmission TM has not formed a forward shift speed, the determining part 16 ends the determination of a state of the first engagement device CL1.

If the determining part 16 determines that the input rotational speed Nm is greater than zero, the determining part 16 determines whether the input rotational speed Nm is higher than the internal combustion engine rotational speed Ne and the rotational speed difference ΔN between the input rotational speed Nm and the internal combustion engine rotational speed Ne is greater than the third threshold value TH3 (STEP3). This determination can be made, for example, based on information from the rotating electrical machine control part 12 and the internal combustion engine control device 20. The third threshold value TH3 is a positive value determined in advance by experiment, etc.

On the other hand, if the determining part 16 determines that the input rotational speed Nm is less than or equal to zero, the determining part 16 ends the determination of a state of the first engagement device CL1.

If the determining part 16 determines that the rotational speed difference ΔN between the input rotational speed Nm and the internal combustion engine rotational speed Ne is greater than the third threshold value TH3, the determining part 16 obtains from the communication part 11 an engagement control instruction which is received by the communication part 11 from the instruction device 30 (STEP4).

On the other hand, if the determining part 16 determines that the rotational speed difference ΔN between the input rotational speed Nm and the internal combustion engine rotational speed Ne is less than or equal to the third threshold value TH3, the determining part 16 ends the determination of a state of the first engagement device CL1.

After STEP4, the determining part 16 obtains first hydraulic pressure P1 calculated by the hydraulic pressure information obtaining part 14 (STEPS).

Then, the determining part 16 determines whether the engagement control instruction is a disengagement instruction to bring the first engagement device CL1 into a disengaged state and the first hydraulic pressure P1 is greater than the first threshold value TH1 (STEP6). The first threshold value TH1 is a threshold value for determining whether the first engagement device CL1 is in an engaged state, and when the first hydraulic pressure P1 is greater than the first threshold value TH1, it is determined that the first engagement device CL1 is in an engaged state.

If the determining part 16 determines that the engagement control instruction is a disengagement instruction to bring the first engagement device CL1 into a disengaged state and the first hydraulic pressure P1 is greater than the first threshold value TH1, the determining part 16 obtains acceleration A of the vehicle calculated by the acceleration information obtaining part 15 (STEP7).

On the other hand, if the determining part 16 determines that the engagement control instruction is not a disengagement instruction to bring the first engagement device CL1 into a disengaged state, or the first hydraulic pressure P1 is less than or equal to the first threshold value TH1, the determining part 16 ends the determination of a state of the first engagement device CL1.

After STEP7, the determining part 16 determines whether the acceleration A of the vehicle has a negative value smaller than the second threshold value TH2 (STEP8). The second threshold value TH2 can be set, for example, based on the following equation:

Second threshold value TH2=a negative torque at which sudden deceleration occurs/the circumference of the wheels W/the weight of the vehicle

Here, the negative torque at which sudden deceleration occurs is a negative torque (e.g., −1000 N·m) assumed to cause sudden deceleration in the vehicle that should be avoided.

If the determining part 16 determines that the acceleration A of the vehicle has a negative value smaller than the second threshold value TH2, the determining part 16 makes a tentative determination that the state of the first engagement device CL1 is an engagement abnormality (hereinafter, referred to as “tentative determination of an engagement abnormality”) (STEP9).

On the other hand, if the determining part 16 determines that the acceleration A of the vehicle is greater than or equal to the second threshold value TH2, the determining part 16 ends the determination of a state of the first engagement device CL1.

Subsequently, the determining part 16 determines whether a period of time Δt has elapsed from when the tentative determination of an engagement abnormality is initially made (STEP10). If the period of time Δt has not elapsed from when the tentative determination of an engagement abnormality is initially made, the determining part 16 makes a determination of a state of the first engagement device CL1 all over again. On the other hand, if the period of time Δt has elapsed from when the tentative determination of an engagement abnormality is initially made, the determining part 16 makes a final determination that the state of the first engagement device CL1 is an engagement abnormality (hereinafter, referred to as “final determination of an engagement abnormality”) (STEP11).

After making the final determination of an engagement abnormality, the determining part 16 performs first control that brings the first engagement device CL1 into a disengaged state (STEP12). Here, the determining part 16 performs, as the first control, first disengagement control that allows the engagement control part 13 to perform control again to bring the first engagement device CL1 into a disengaged state, and when the first engagement device CL1 has not been able to be brought into a disengaged state by the first disengagement control, the determining part 16 performs second disengagement control that allows the first engagement control valve Va1 to operate such that the first engagement device CL1 is forcefully brought into a disengaged state. Furthermore, when the first engagement device CL1 has not been able to be brought into a disengaged state by the second disengagement control, third disengagement control that allows the engagement control part 13 to restart is performed. Note that the determining part 16 may be configured to perform those controls in a different order than that described above, or may be configured to perform any one or two of those controls.

In addition, in parallel with the above-described first control, the determining part 16 performs second control that interrupts transmission of drive power between the rotating electrical machine MG and the output shaft O (STEP13). Here, the determining part 16 performs, as the second control, normal neutral control that brings the transmission TM into a neutral state in normal control that allows the engagement control part 13 to control the states of engagement of the second engagement devices CL2 in the transmission TM, and when the transmission TM has not been able to be brought into a neutral state by the normal neutral control, the determining part 16 performs forced neutral control that allows the second engagement control valves Va2 to operate such that the second engagement devices CL2 are forcefully brought into a disengaged state.

3-2. Time Chart

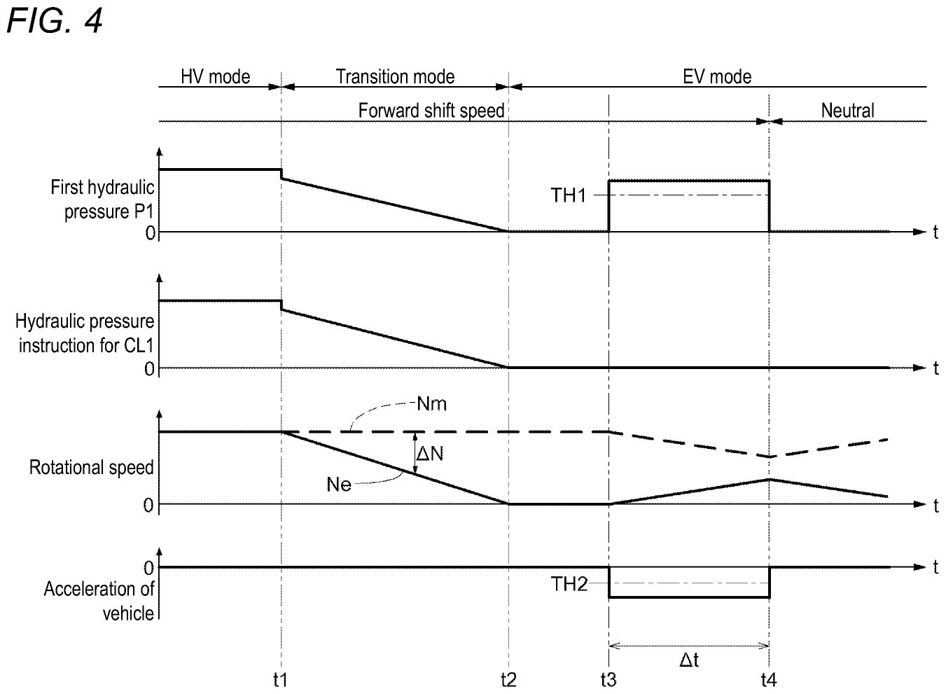

FIG. 4 shows a time chart for an example of a determination of a state of the first engagement device CL1 by the determining part 16. FIG. 4 shows a determination of a state of the first engagement device CL1 by the determining part 16 when it is determined that the first engagement device CL1 has an engagement abnormality during traveling of the vehicle at a constant speed with a forward shift speed formed by the transmission TM.

As shown in FIG. 4, the vehicle is controlled in HV mode until time t1. The HV mode is a mode in which the vehicle travels by drive power of both the internal combustion engine ENG and the rotating electrical machine MG, with the first engagement device CL1 being in a direct-coupling engaged state.

Then, the vehicle goes through a transition mode from time t1 to t2, and is then controlled in EV mode from time t2. The transition mode is a mode performed along the way of transitioning from the HV mode to the EV mode. The EV mode is a mode in which the vehicle travels by drive power of the rotating electrical machine MG without using drive power of the internal combustion engine ENG, with the first engagement device CL1 being in a disengaged state.

At time t1, in order to end the HV mode, a hydraulic pressure instruction for the first engagement device CL1 is reduced. Then, in order to achieve zero at time t2, the hydraulic pressure instruction for the first engagement device CL1 is gradually reduced. Accordingly, first hydraulic pressure P1 supplied to the first engagement device CL1 also gradually decreases over a period from time t1 to t2 and reaches zero at time t2. Note that in practice, delay in response of the first hydraulic pressure P1 to the hydraulic pressure instruction for the first engagement device CL1 occurs, but for convenience of description, it is assumed that there is no such delay in response.

In addition, at time t1, in order to end the HV mode, the internal combustion engine control device 20 brings the internal combustion engine ENG into a combustion stop state. As described above, since the first hydraulic pressure P1 gradually decreases over the period from time t1 to t2, the engagement pressure of the first engagement device CL1 also gradually decreases and reaches zero at time t2. That is, at time t2, the first engagement device CL1 goes into a disengaged state. Hence, the internal combustion engine rotational speed Ne gradually decreases and reaches zero at time t2. In other words, the rotational speed difference ΔN between the input rotational speed Nm and the internal combustion engine rotational speed Ne, which is zero at time t1 gradually increases over the period from time t1 to t2, and becomes maximum at time t2. Note that here it is assumed that the rotating electrical machine MG outputs a positive torque so that the input rotational speed Nm is maintained constant.

At time t2, along with the first hydraulic pressure P1 reaching zero, the first engagement device CL1 goes into a disengaged state and the EV mode starts. The input rotational speed Nm is maintained constant over a period from time t2 to t3, too, and the vehicle travels forward at a constant speed.

In such a state, at time t3, a situation in which the first hydraulic pressure P1 increases to a level where the first engagement device CL1 goes into an engaged state (the first hydraulic pressure P1 exceeds the first threshold value TH1) occurs in contrast to the hydraulic pressure instruction outputted from the instruction device 30. Such a situation, though the chance is very little, is likely to occur due to a failure of the engagement control part 13, a computation error of the engagement control part 13, a failure of the first engagement device CL1, etc.

Along with the first engagement device CL1 going into an engaged state, the input rotational speed Nm which is the rotational speed of the rotating electrical machine MG decreases by the inertia torque of the internal combustion engine ENG with the internal combustion engine rotational speed Ne being zero. On the other hand, the internal combustion engine rotational speed Ne increases. As a result, the vehicle decelerates to the extent that the acceleration A of the vehicle reaches a negative value smaller than the second threshold value TH2. Note that here it is assumed that the rotational speed difference ΔN between the input rotational speed Nm and the internal combustion engine rotational speed Ne is greater than the third threshold value TH3 over a period from time t3 to t4.

At time t3, the above-described tentative determination of an engagement abnormality is made. Then, at a point in time (time t4) when the period of time Δt has elapsed without resolving the tentative determination of an engagement abnormality before the period of time Δt has elapsed from when the tentative determination of an engagement abnormality is initially made, the above-described final determination of an engagement abnormality is made.

At time t4, the above-described first control and second control are performed. By the first control, the first hydraulic pressure P1 reaches zero and the first engagement device CL1 goes into a disengaged state. Accordingly, the input rotational speed Nm gradually increases and the internal combustion engine rotational speed Ne gradually decreases toward zero. In addition, by the second control, a state in which transmission of drive power between the rotating electrical machine MG and the output shaft O is interrupted is obtained. Here, by neutral control which is the second control, the state of the transmission TM goes into a neutral state in which drive power is not transmitted. Note that since traveling of the vehicle cannot be continued when the transmission TM is in the neutral state, it is preferred to perform control such that when traveling of the vehicle becomes stable after the neutral control, the state is brought back to an original drive transmission state (a state in which a forward shift speed is formed) in the shortest possible time.

### Second Embodiment

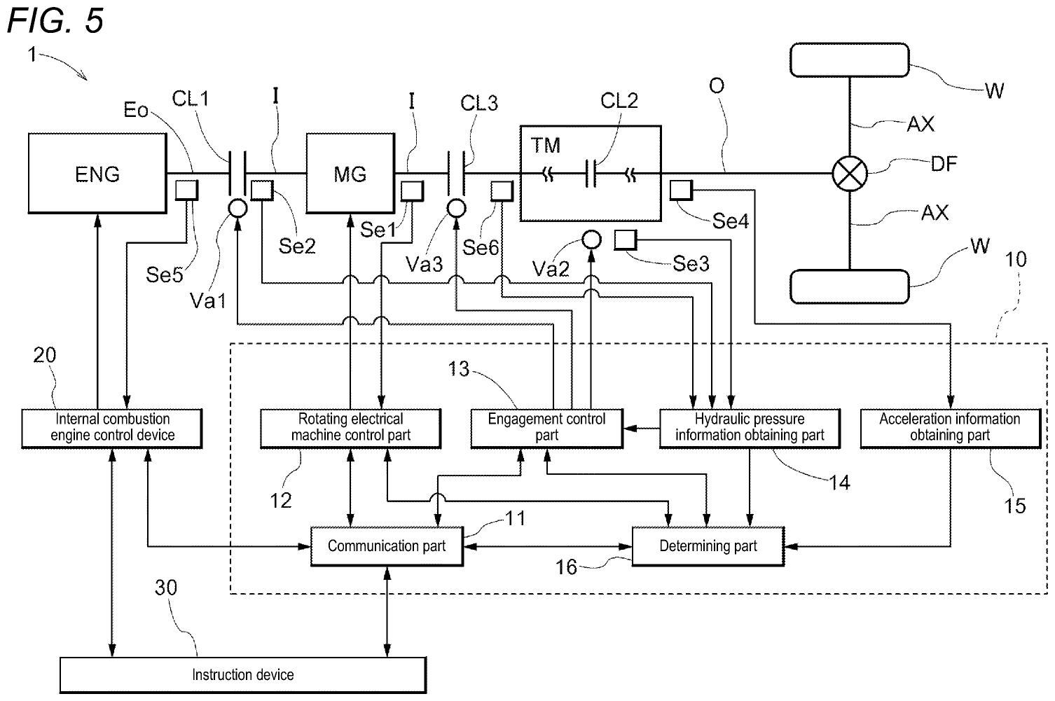

In the following, a control device 10 for a vehicle drive device 1 according to a second embodiment will be described with reference to FIG. 5. The present embodiment differs from the above-described first embodiment in that the vehicle drive device 1 includes a third engagement device CL3. In the following, differences from the above-described first embodiment will be mainly described. Note that points that are not particularly described are the same as those of the above-described first embodiment.

As shown in FIG. 5, in the present embodiment, the vehicle drive device 1 further includes the third engagement device CL3 that connects or disconnects transmission of drive power between the rotating electrical machine MG and the transmission TM. The third engagement device CL3 is an engagement device that operates by hydraulic pressure as with the first engagement device CL1 and the second engagement devices CL2. In the present embodiment, the third engagement device CL3 is a friction engagement device as with the first engagement device CL1 and the second engagement devices CL2.

In the present embodiment, the engagement control part 13 controls the state of engagement of the third engagement device CL3. In the present embodiment, the engagement control part 13 controls a third engagement control valve Va3 such that third hydraulic pressure P3 supplied to the third engagement device CL3 matches target hydraulic pressure (hydraulic pressure instruction) of the third engagement device CL3 instructed by the instruction device 30. In the present embodiment, the third engagement control valve Va3 is a solenoid valve that adjusts hydraulic pressure to be supplied to a hydraulic servomechanism of the third engagement device CL3, based on current applied thereto.

In the present embodiment, the hydraulic pressure information obtaining part 14 obtains hydraulic pressure information indicating third hydraulic pressure P3 supplied to the third engagement device CL3. In this example, the hydraulic pressure information obtaining part 14 calculates third hydraulic pressure P3 based on an output signal from a third hydraulic pressure sensor Se6. The third hydraulic pressure sensor Se6 is a sensor for detecting third hydraulic pressure P3 supplied to the third engagement device CL3. The third hydraulic pressure sensor Se6 is provided, for example, in an oil passage connecting the third engagement control valve Va3 to the hydraulic servomechanism of the third engagement device CL3.

In the present embodiment, the second control performed by the determining part 16 includes engagement disengagement control that brings the third engagement device CL3 into a disengaged state. The engagement disengagement control includes normal engagement disengagement control that brings the third engagement device CL3 into a disengaged state in normal control that allows the engagement control part 13 to control the state of engagement of the third engagement device CL3; and forced engagement disengagement control that allows the third engagement control valve Va3 to operate such that the third engagement device CL3 is forcefully brought into a disengaged state.

In the present embodiment, in the normal engagement disengagement control, the determining part 16 controls the normal control part 131 in the engagement control part 13 to bring the third engagement device CL3 into a disengaged state. In addition, in the forced engagement disengagement control, the determining part 16 controls the forced control part 132 in the engagement control part 13 to allow the third engagement control valve Va3 to operate such that the third engagement device CL3 is forcefully brought into a disengaged state. The forced control part 132 forcefully brings the third engagement device CL3 into a disengaged state, for example, by stopping supply of current to the third engagement control valve Va3. Note that the determining part 16 may be configured to control both the normal control part 131 and the forced control part 132 in the forced engagement disengagement control such that the third engagement device CL3 is brought into a disengaged state. By this, the third engagement device CL3 can be brought into a disengaged state with high reliability.

In the present embodiment, the determining part 16 performs, as the second control, at least one of the neutral control and the engagement disengagement control.

### Other Embodiments

(1) The above-described embodiments describe, as an example, a configuration in which the acceleration A of the vehicle is calculated based on a change in the rotational speed of the output shaft O (the differential value of rotational speed of the output shaft O). However, the configuration is not limited thereto and may be such that the acceleration A of the vehicle is detected by an acceleration sensor.

(2) The above-described embodiments describe, as an example, a configuration in which a determination of a state of the first engagement device CL1 is made during traveling of the vehicle, with the rotating electrical machine MG outputting a positive torque. However, the configuration is not limited thereto and may be such that a determination of a state of the first engagement device CL1 is made when the vehicle is coasting without the rotating electrical machine MG outputting torque or when the vehicle is decelerating by the rotating electrical machine MG outputting a negative torque.

(3) The above-described embodiments describe, as an example, a configuration in which a determination of a state of the first engagement device CL1 is not made when the rotational speed difference ΔN between the input rotational speed Nm and the internal combustion engine rotational speed Ne is less than or equal to the third threshold value TH3. However, the configuration is not limited thereto and may be such that a determination of a state of the first engagement device CL1 is made whatever the value of the rotational speed difference ΔN.

(4) The above-described embodiments describe, as an example, a configuration in which a final determination of an engagement abnormality is made when the period of time Δt has elapsed from when a tentative determination of an engagement abnormality is initially made. However, the configuration is not limited thereto and may be such that a final determination of an engagement abnormality is made without making a tentative determination of an engagement abnormality.

(5) The above-described embodiments describe, as an example, a configuration in which the transmission TM is a stepped transmission having a shift speed determined based on the states of engagement of the second engagement devices CL2. However, the configuration is not limited thereto and the transmission TM may be a continuously variable transmission. In this case, engagement devices that switch between forward, reverse, and neutral states correspond to the second engagement devices CL2.

(6) The above-described embodiments describe, as an example, a configuration in which when the determining part 16 determines that the state of the first engagement device CL1 is an engagement abnormality, the determining part 16 performs both the first control and the second control. However, the configuration is not limited thereto and may be such that only either one of the first control and the second control is performed. Alternatively, the configuration may be such that control other than the first control and the second control is performed. For example, when the determining part 16 determines that the state of the first engagement device CL1 is an engagement abnormality, the determining part 16 may control the internal combustion engine control device 20 to allow the internal combustion engine ENG to start. According to this configuration, even when the first engagement device CL1 unintentionally goes into an engaged state, deceleration of the vehicle can be avoided.

(7) The above-described embodiments describe, as an example, a configuration in which in the time chart showing a determination of a state of the first engagement device CL1 by the determining part 16, the input rotational speed Nm gradually increases at and after time t4. However, the configuration is not limited thereto, and depending on the control state of the rotating electrical machine MG, at and after time t4, the input rotational speed Nm may gradually decrease or may be maintained constant.

(8) The above-described embodiments describe, as an example, a configuration in which the communication part 11 receives an instruction such as an engagement control instruction from the instruction device 30 by performing communication with the instruction device 30. However, the configuration is not limited thereto and may be such that a part of the control device 10 (e.g., the communication part 11) outputs an instruction such as an engagement control instruction.

(9) Note that a configuration disclosed in each of the above-described embodiments can also be applied in combination with a configuration disclosed in another embodiment as long as a contradiction does not arise. For other configurations, too, the embodiments disclosed in this specification are in all respects merely illustrative. Thus, various modifications can be made therein as appropriate without departing from the true spirit and scope of the present disclosure.

### Summary of the Above-Described Embodiments

A summary of a control device (10) for a vehicle drive device (1) described above will be described below.

A control device (10) for a vehicle drive device (1) is

the control device (10) whose control target is the vehicle drive device (1) in which in a power transmission path connecting an input member (I) drive-coupled to an internal combustion engine (ENG) to an output member (O) drive-coupled to wheels (W), a first engagement device (CL1) that operates by hydraulic pressure, a rotating electrical machine (MG), and a transmission (TM) are provided in this order from an internal combustion engine (ENG) side, the control device (10) including:

an engagement control part (13) that controls a state of engagement of the first engagement device (CL1) based on an engagement control instruction;

a hydraulic pressure information obtaining part (14) that obtains hydraulic pressure information indicating first hydraulic pressure (P1) supplied to the first engagement device (CL1);

an acceleration information obtaining part (15) that obtains acceleration information indicating acceleration (A) of a vehicle on which the vehicle drive device (1) is provided; and

a determining part (16) that determines a state of the first engagement device (CL1), and

when

an input rotational speed (Nm) is greater than zero and a state of the transmission (TM) is a drive transmission state in which drive power is transmitted, the input rotational speed (Nm) being a rotational speed of the rotating electrical machine (MG);

the engagement control instruction is a disengagement instruction to bring the first engagement device (CL1) into a disengaged state;

the first hydraulic pressure (P1) indicated by the hydraulic pressure information is greater than a first threshold value (TH1); and

acceleration (A) indicated by the acceleration information has a negative value smaller than a second threshold value (TH2),

the determining part (16) determines that the state of the first engagement device (CL1) is an engagement abnormality where the state of the first engagement device (CL1) is an engaged state in contrast to the disengagement instruction.

According to this configuration, when the first engagement device (CL1) goes into an engaged state in contrast to a disengagement instruction and the acceleration (A) of the vehicle becomes a negative value smaller than a specified value during acceleration or deceleration of the vehicle or during coasting of the vehicle in a state in which drive power of the rotating electrical machine (MG) is transmitted to the wheels (W), it is determined that the state of the first engagement device (CL1) is an engagement abnormality. Therefore, unintended deceleration of the vehicle in a state in which drive power of the rotating electrical machine (MG) is transmitted to the wheels (W) can be appropriately determined.

Here, it is preferred that when the determining part (16) determines that the state of the first engagement device (CL1) is the engagement abnormality, the determining part (16) perform at least one of first control that brings the first engagement device (CL1) into a disengaged state and second control that interrupts transmission of drive power between a rotating electrical machine (MG) and an output member (O).

According to this configuration, when it is determined that the state of the first engagement device (CL1) is an engagement abnormality, at least one of interruption of power transmission between the internal combustion engine (ENG) and the rotating electrical machine (MG) and interruption of power transmission between the rotating electrical machine (MG) and the output member (O) is performed. Hence, unintended transmission of inertia torque of the internal combustion engine (ENG) to the wheels (W) caused by an engagement abnormality in the first engagement device (CL1) can be avoided. Therefore, unintended deceleration of the vehicle in a state in which drive power of the rotating electrical machine (MG) is transmitted to the wheels (W) can be avoided.

A control device (10) for a vehicle drive device (1) is

the control device (10) whose control target is the vehicle drive device (1) in which in a power transmission path connecting an input member (I) drive-coupled to an internal combustion engine (ENG) to an output member (O) drive-coupled to wheels (W), a first engagement device (CL1) that operates by hydraulic pressure, a rotating electrical machine (MG), and a transmission (TM) are provided in this order from an internal combustion engine (ENG) side, the control device (10) including:

an engagement control part (13) that controls a state of engagement of the first engagement device (CL1) based on an engagement control instruction;

a hydraulic pressure information obtaining part (14) that obtains hydraulic pressure information indicating first hydraulic pressure (P1) supplied to the first engagement device (CL1);

an acceleration information obtaining part (15) that obtains acceleration information indicating acceleration (A) of a vehicle on which the vehicle drive device (1) is provided; and

a determining part (16) that determines a state of the first engagement device (CL1), and

when

an input rotational speed (Nm) is greater than zero and a state of the transmission (TM) is a drive transmission state in which drive power is transmitted, the input rotational speed (Nm) being a rotational speed of the rotating electrical machine (MG);

the engagement control instruction is a disengagement instruction to bring the first engagement device (CL1) into a disengaged state;

the first hydraulic pressure (P1) indicated by the hydraulic pressure information is greater than a first threshold value (TH1); and

acceleration (A) indicated by the acceleration information has a negative value smaller than a second threshold value (TH2),

the determining part (16) performs at least one of first control that brings the first engagement device (CL1) into a disengaged state and second control that interrupts transmission of drive power between a rotating electrical machine (MG) and an output member (O).

According to this configuration, when the first engagement device (CL1) goes into an engaged state in contrast to a disengagement instruction and the acceleration (A) of the vehicle becomes a negative value smaller than a specified value during acceleration or deceleration of the vehicle or during coasting of the vehicle in a state in which drive power of the rotating electrical machine (MG) is transmitted to the wheels (W), at least one of interruption of power transmission between the internal combustion engine (ENG) and the rotating electrical machine (MG) and interruption of power transmission between the rotating electrical machine (MG) and the output member (O) is performed. Hence, unintended transmission of inertia torque of the internal combustion engine (ENG) to the wheels (W) caused by an engagement abnormality in the first engagement device (CL1) can be avoided. Therefore, unintended deceleration of the vehicle in a state in which drive power of the rotating electrical machine (MG) is transmitted to the wheels (W) can be avoided.

Here, it is preferred that the first control include first disengagement control that allows the engagement control part (13) to perform control again to bring the first engagement device (CL1) into a disengaged state.

Depending on the cause of an engagement abnormality in the first engagement device (CL1), the engagement abnormality in the first engagement device (CL1) may be resolved only by allowing the engagement control part (13) to perform control again to bring the first engagement device (CL1) into a disengaged state. According to this configuration, the engagement control part (13) is allowed to perform control again to bring the first engagement device (CL1) into a disengaged state, and thus, depending on the cause of an engagement abnormality in the first engagement device (CL1), the engagement abnormality in the first engagement device (CL1) can be resolved while the level of influence on a vehicle travel state is minimized.

In addition, it is preferred that the first control include second disengagement control that allows a first engagement control valve (Va1) to operate such that the first engagement device (CL1) is forcefully brought into a disengaged state, the first engagement control valve (Va1) controlling the first hydraulic pressure (P1) supplied to the first engagement device (CL1).

According to this configuration, even when an engagement abnormality in the first engagement device (CL1) cannot be resolved by the engagement control part (13) performing control to bring the first engagement device (CL1) into a disengaged state, the first engagement device (CL1) can be forcefully brought into a disengaged state by controlling first hydraulic pressure (P1) supplied to the first engagement device (CL1). Therefore, the engagement abnormality in the first engagement device (CL1) can be resolved with high reliability.

In addition, it is preferred that the first control include third disengagement control that allows the engagement control part (13) to restart.

When the cause of an engagement abnormality in the first engagement device (CL1) results from the state of the engagement control part (13), e.g., a computation error of the engagement control part (13), the engagement abnormality in the first engagement device (CL1) may be resolved only by restarting the engagement control part (13). According to this configuration, since the engagement control part (13) is restarted as the first control, when the cause of an engagement abnormality in the first engagement device (CL1) results from the state of the engagement control part (13), the engagement abnormality in the first engagement device (CL1) can be appropriately resolved.

In addition, it is preferred that the second control include neutral control that brings the state of the transmission (TM) into a neutral state in which drive power is not transmitted.

According to this configuration, only by bringing the state of the transmission (TM) into a neutral state, power transmission between the rotating electrical machine (MG) and the output member (O) can be interrupted. Thus, the second control can be easily performed.

In a configuration in which the second control includes the neutral control,

it is preferred that

the transmission (TM) include one or more second engagement devices (CL2) that are brought into an engaged state when a shift speed is formed, and

the neutral control include forced neutral control that allows a second engagement control valve (Va2) to operate such that the second engagement devices (CL2) are forcefully brought into a disengaged state, the second engagement control valve (Va2) controlling second hydraulic pressure (P2) supplied to the second engagement devices (CL2).

According to this configuration, as the neutral control, the second engagement control valve (Va2) is allowed to operate such that the second engagement devices (CL2) are forcefully brought into a disengaged state, and thus, the transmission (TM) can be brought into a neutral state with high reliability. By this, even when an engagement abnormality in the first engagement device (CL1) occurs, unintended transmission of inertia torque of the internal combustion engine (ENG) to the wheels (W) can be avoided. Therefore, unintended deceleration of the vehicle in a state in which drive power of the rotating electrical machine (MG) is transmitted to the wheels (W) can be avoided.

In addition, it is preferred that

the control device (10) further include a third engagement device (CL3) that connects or disconnects transmission of drive power between the rotating electrical machine (MG) and the transmission (TM), and

the second control include engagement disengagement control that brings the third engagement device (CL3) into a disengaged state.

According to this configuration, only by bringing the third engagement device (CL3) into a disengaged state, power transmission between the rotating electrical machine (MG) and the output member (O) can be interrupted. Thus, the second control can be easily performed.

In a configuration in which the second control includes the engagement disengagement control,

it is preferred that the engagement disengagement control include forced engagement disengagement control that allows a third engagement control valve (Va3) to operate such that the third engagement device (CL3) is forcefully brought into a disengaged state, the third engagement control valve (Va3) controlling third hydraulic pressure (P3) supplied to the third engagement device (CL3).

According to this configuration, as the engagement disengagement control, the third engagement control valve (Va3) is allowed to operate such that the third engagement device (CL3) is forcefully brought into a disengaged state, and thus, the third engagement device (CL3) can be brought into a disengaged state with high reliability. By this, even when an engagement abnormality in the first engagement device (CL1) occurs, unintended transmission of inertia torque of the internal combustion engine (ENG) to the wheels (W) can be avoided. Therefore, unintended deceleration of the vehicle in a state in which drive power of the rotating electrical machine (MG) is transmitted to the wheels (W) can be avoided.

In addition, it is preferred that the determining part (16)

determine a state of the first engagement device (CL1) by the determining part (16) when the input rotational speed (Nm) is higher than an internal combustion engine rotational speed (Ne) and a difference (ΔN) between the input rotational speed (Nm) and the internal combustion engine rotational speed (Ne) is greater than a third threshold value (TH3), the internal combustion engine rotational speed (Ne) being a rotational speed of the internal combustion engine (ENG), and

not determine a state of the first engagement device (CL1) by the determining part (16) when the difference (ΔN) between the input rotational speed (Nm) and the internal combustion engine rotational speed (Ne) is less than or equal to the third threshold value (TH3).

Even when an engagement abnormality in the first engagement device (CL1) occurs, there is a low likelihood of sudden deceleration of the vehicle, except when the input rotational speed (Nm) is higher than the internal combustion engine rotational speed (Ne) and the difference (ΔN) between the input rotational speed (Nm) and the internal combustion engine rotational speed (Ne) is relatively large. According to this configuration, when the input rotational speed (Nm) is higher than the internal combustion engine rotational speed (Ne) and the difference (ΔN) between the input rotational speed (Nm) and the internal combustion engine rotational speed (Ne) is less than or equal to the third threshold value (TH3), a determination of a state of the first engagement device (CL1) is not made. By this, determining a state of the first engagement device (CL1) even for a case of a low likelihood of sudden deceleration of the vehicle does not occur, and thus, a computation load on the determining part (16) can be reduced.

### INDUSTRIAL APPLICABILITY

A technique according to the present disclosure can be used in a control device whose control target is a vehicle drive device in which in a power transmission path connecting an input member drive-coupled to an internal combustion engine to an output member drive-coupled to wheels, an engagement device that operates by hydraulic pressure, a rotating electrical machine, and a transmission are provided in this order from an internal combustion engine side.

It is preferred that the control device (10) further include a communication part (11) that receives the engagement control instruction from an instruction device (30) by performing communication with the instruction device (30), the instruction device (30) outputting the engagement control instruction.

According to this configuration, the instruction device (30) that outputs an engagement control instruction is provided separately from the control device (10) including the communication part (11) that receives the engagement control instruction from the instruction device (30). By this, a load on the control device (10) can be reduced.

### REFERENCE SIGNS LIST

1: Vehicle drive device, 10: Control device, 11: Communication part, 12: Rotating electrical machine control part, 13: Engagement control part, 14: Hydraulic pressure information obtaining part, 15: Acceleration information obtaining part, 16: Determining part, 30: Instruction device, ENG: Internal combustion engine, MG: Rotating electrical machine, I: Input shaft, O: Output shaft, TM: Transmission, CL1: First engagement device, CL2: Second engagement device, and W: Wheel

1. A control device for a vehicle drive device, a control target for the control device being the vehicle drive device in which in a power transmission path connecting an input member drive-coupled to an internal combustion engine to an output member drive-coupled to wheels, a first engagement device that operates by hydraulic pressure, a rotating electrical machine, and a transmission are provided in this order from an internal combustion engine side, the control device comprising:
an engagement control part that controls a state of engagement of the first engagement device based on an engagement control instruction;
a hydraulic pressure information obtaining part that obtains hydraulic pressure information indicating first hydraulic pressure supplied to the first engagement device;
an acceleration information obtaining part that obtains acceleration information indicating acceleration of a vehicle on which the vehicle drive device is provided; and
a determining part that determines a state of the first engagement device,
wherein
when
an input rotational speed is greater than zero and a state of the transmission is a drive transmission state in which drive power is transmitted, the input rotational speed being a rotational speed of the rotating electrical machine;
the engagement control instruction is a disengagement instruction to bring the first engagement device into a disengaged state;
the first hydraulic pressure indicated by the hydraulic pressure information is greater than a first threshold value; and
acceleration indicated by the acceleration information has a negative value smaller than a second threshold value,
the determining part determines that the state of the first engagement device is an engagement abnormality where the state of the first engagement device is an engaged state in contrast to the disengagement instruction.

2. The control device for a vehicle drive device according to claim 1, wherein when the determining part determines that the state of the first engagement device is the engagement abnormality, the determining part performs at least one of first control that brings the first engagement device into a disengaged state and second control that interrupts transmission of drive power between the rotating electrical machine and the output member.

3. A control device for a vehicle drive device, a control target for the control device being the vehicle drive device in which in a power transmission path connecting an input member drive-coupled to an internal combustion engine to an output member drive-coupled to wheels, a first engagement device that operates by hydraulic pressure, a rotating electrical machine, and a transmission are provided in this order from an internal combustion engine side, the control device comprising:
an engagement control part that controls a state of engagement of the first engagement device based on an engagement control instruction;
a hydraulic pressure information obtaining part that obtains hydraulic pressure information indicating first hydraulic pressure supplied to the first engagement device;
an acceleration information obtaining part that obtains acceleration information indicating acceleration of a vehicle on which the vehicle drive device is provided; and
a determining part that determines a state of the first engagement device,
wherein
when
an input rotational speed is greater than zero and a state of the transmission is a drive transmission state in which drive power is transmitted, the input rotational speed being a rotational speed of the rotating electrical machine;
the engagement control instruction is a disengagement instruction to bring the first engagement device into a disengaged state;
the first hydraulic pressure indicated by the hydraulic pressure information is greater than a first threshold value; and
acceleration indicated by the acceleration information has a negative value smaller than a second threshold value,
the determining part performs at least one of first control that brings the first engagement device into a disengaged state and second control that interrupts transmission of drive power between the rotating electrical machine and the output member.

4. The control device for a vehicle drive device according to claim 2, wherein the first control includes first disengagement control that allows the engagement control part to perform control again to bring the first engagement device into a disengaged state.

5. The control device for a vehicle drive device according to claim 2, wherein the first control includes second disengagement control that allows a first engagement control valve to operate such that the first engagement device is forcefully brought into a disengaged state, the first engagement control valve controlling the first hydraulic pressure supplied to the first engagement device.

6. The control device for a vehicle drive device according to claim 2, wherein the first control includes third disengagement control that allows the engagement control part to restart.

7. The control device for a vehicle drive device according to claim 2, wherein the second control includes neutral control that brings the state of the transmission into a neutral state in which drive power is not transmitted.

8. The control device for a vehicle drive device according to claim 7, wherein
the transmission includes one or more second engagement devices that are brought into an engaged state when a shift speed is formed, and
the neutral control includes forced neutral control that allows a second engagement control valve to operate such that the second engagement devices are forcefully brought into a disengaged state, the second engagement control valve controlling second hydraulic pressure supplied to the second engagement devices.

9. The control device for a vehicle drive device according to claim 2, further comprising a third engagement device that connects or disconnects transmission of drive power between the rotating electrical machine and the transmission,
wherein
the second control includes engagement disengagement control that brings the third engagement device into a disengaged state.

10. The control device for a vehicle drive device according to claim 9, wherein the engagement disengagement control includes forced engagement disengagement control that allows a third engagement control valve to operate such that the third engagement device is forcefully brought into a disengaged state, the third engagement control valve controlling third hydraulic pressure supplied to the third engagement device.

11. The control device for a vehicle drive device according to claim 1, wherein the determining part
determines a state of the first engagement device by the determining part when the input rotational speed is higher than an internal combustion engine rotational speed and a difference between the input rotational speed and the internal combustion engine rotational speed is greater than a third threshold value, the internal combustion engine rotational speed being a rotational speed of the internal combustion engine, and
does not determine a state of the first engagement device by the determining part when the difference between the input rotational speed and the internal combustion engine rotational speed is less than or equal to the third threshold value.

12. The control device for a vehicle drive device according to claim 1, further comprising a communication part that receives the engagement control instruction from an instruction device by performing communication with the instruction device, the instruction device outputting the engagement control instruction.

13. The control device for a vehicle drive device according to claim 3, wherein the first control includes first disengagement control that allows the engagement control part to perform control again to bring the first engagement device into a disengaged state.

14. The control device for a vehicle drive device according to claim 3, wherein the first control includes second disengagement control that allows a first engagement control valve to operate such that the first engagement device is forcefully brought into a disengaged state, the first engagement control valve controlling the first hydraulic pressure supplied to the first engagement device.

15. The control device for a vehicle drive device according to claim 3, wherein the first control includes third disengagement control that allows the engagement control part to restart.

16. The control device for a vehicle drive device according to claim 3, wherein the second control includes neutral control that brings the state of the transmission into a neutral state in which drive power is not transmitted.

17. The control device for a vehicle drive device according to claim 16, wherein
the transmission includes one or more second engagement devices that are brought into an engaged state when a shift speed is formed, and
the neutral control includes forced neutral control that allows a second engagement control valve to operate such that the second engagement devices are forcefully brought into a disengaged state, the second engagement control valve controlling second hydraulic pressure supplied to the second engagement devices.

18. The control device for a vehicle drive device according to claim 3, further comprising a third engagement device that connects or disconnects transmission of drive power between the rotating electrical machine and the transmission,
wherein
the second control includes engagement disengagement control that brings the third engagement device into a disengaged state.

19. The control device for a vehicle drive device according to claim 18, wherein the engagement disengagement control includes forced engagement disengagement control that allows a third engagement control valve to operate such that the third engagement device is forcefully brought into a disengaged state, the third engagement control valve controlling third hydraulic pressure supplied to the third engagement device.

20. The control device for a vehicle drive device according to claim 3, wherein the determining part
determines a state of the first engagement device by the determining part when the input rotational speed is higher than an internal combustion engine rotational speed and a difference between the input rotational speed and the internal combustion engine rotational speed is greater than a third threshold value, the internal combustion engine rotational speed being a rotational speed of the internal combustion engine, and
does not determine a state of the first engagement device by the determining part when the difference between the input rotational speed and the internal combustion engine rotational speed is less than or equal to the third threshold value.
